(19) United States
(12) Patent Application Publication
(10) Pub. No.: US 2025/0251318 A1
(43) Pub. Date: Aug. 7, 2025

(54) TEST SPECIMENS WITH ELECTRIC DISCHARGE MACHINING MARKINGS PROVIDING PROPERTIES IDENTIFICATION

(71) Applicant: Product Innovation and Engineering, LLC, St. James, MO (US)

(72) Inventor: Fuewen LIOU, Rolla, MO (US)

(21) Appl. No.: 19/041,759

(22) Filed: Jan. 30, 2025

Related U.S. Application Data
(60) Provisional application No. 63/548,674, filed on Feb. 1, 2024.

(51) Int. Cl. G01N 1/28; G01N 1/04

(52) U.S. Cl. CPC G01N 1/286; G01N 1/04

(57) ABSTRACT

A test specimen of a material has a marking on the test specimen that identifies at least one property of the material of the test specimen. The marking is integral with the test specimen and produced by electric discharge machining, micro-machining, and/or laser machining on the test specimen as the test specimen was produced by electric discharge machining, micro-machining, and/or laser machining from the material.

### CROSS-REFERENCE TO RELATED APPLICATION

This application claims the benefit and priority of U.S. Provisional Patent Application No. 63/548,674 filed Feb. 1, 2024. The entire disclosure this provisional patent application is incorporated herein by reference.

### FIELD

The present disclosure generally relates to test specimens with markings that provide properties identification of the test specimens.

### BACKGROUND

This section provides background information related to the present disclosure which is not necessarily prior art.

Material specimen testing is used in determining properties of the tested material, for example tensile strength, yield or breaking strength and maximum elongation, creep, fatigue, compressive testing and other measurements of material properties. Testing of a material specimen is performed for a variety of purposes, such as selecting a material for a particular application, predicting how the selected material will perform in the application, and predicting how the material will perform when subjected to normal use forces and extreme use forces.

A typical test specimen of a material has a standardized configuration often described as a “dumbbell” or “dog bone” configuration. The typical test specimen configuration is that of a cylindrical rod with a circular cross section, or that of a flat strip with a rectangular cross section. The “dumbbell” configuration of the test specimen provides the specimen with a narrow, gauge section at a center portion of the specimen length and two large shoulder sections at opposite end portions of the specimen length.

It is often desirable to label or mark a test specimen to provide information on or identify properties of the material of the test specimen. For example, it is often desirable to identify the physical properties of the material of the test specimen, the grain structure of the material of the test specimen, an alloy composition of the material of the test specimen, a density of the material of the test specimen, its geometric and/or spatial location and orientation, manufacturing process, etc.

It is difficult to identify properties of a material of a test specimen by labeling the test specimen in a conventional manner. This is particularly true of a miniature test specimen, where the exterior surface area of the miniature test specimen is significantly reduced and there is little area available for applying labeling. For example, test specimens can be labeled by applying written or printed markings on the exterior of the test specimen with paint, ink, or other similar type of marking material. Test specimens can be labeled by attaching an identifying label to the exterior of the test specimen such as a self-adhesive label, a taped label, etc. This labelling typically does not take place immediately after the test specimens are produced, and therefore mistakes can occur due to the delay in the labelling. Additionally, test specimens are typically stored in a batch and can contact each other, are subjected to handling and transportation, and other manufacturing, preparation, and other procedures causing the printed label markings on a test specimen to be obscured or the attached labels to be removed.

### DRAWINGS

The drawings described herein are for illustrative purposes only of selected embodiments and not all possible implementations, and are not intended to limit the scope of the present disclosure.

FIG. 1 is a perspective view of a test specimen according to an exemplary embodiment of this disclosure.

FIG. 2 is a perspective view of a test specimen according to an exemplary embodiment of this disclosure.

FIG. 3 is a front elevation view of the test specimen shown in FIG. 2.

FIG. 4 is a perspective view of a sample block of material from which test specimens as shown in FIGS. 2 and 3 may be produced according to an exemplary embodiment of this disclosure.

FIG. 5 is a perspective view of the first end surfaces or first thickness surfaces of the test specimens shown in FIG. 4 with a wire of an electric discharge machine extending across the end surfaces according to an exemplary embodiment of this disclosure.

FIG. 6 is a perspective view of the first end surfaces or thickness surfaces of the test specimens shown in FIG. 5 having markings produced integrally on the end surfaces according to an exemplary embodiment of this disclosure.

Corresponding reference numerals may indicate corresponding (though not necessarily identical) features throughout the several views of the drawings.

### DETAILED DESCRIPTION

Example embodiments will now be described more fully with reference to the accompanying drawings.

As recognized herein, there is a need for a test specimen having an identification marking formed integrally on the exterior of the test specimen at the time the test specimen is produced to avoid mistakes, where the identification marking identifies physical property(ies) of the material of the test specimen, is immediately formed on the test specimen to avoid mistakes and the marking cannot easily be removed from the exterior of the test specimen. This is particularly needed on a miniature test specimen having a reduced exterior surface area for labeling and due to the large number of these miniature test specimens that are usually under investigation.

In exemplary embodiments disclosed herein, the test specimen is a miniature test specimen, although the concepts of this disclosure can be applied to test specimens of various sizes and the disclosure should not be interpreted as limited to only miniature test specimens. The miniature test specimen has an exterior surface with an elongate length that extends between a first end surface and a second end surface at opposite ends of the test specimen. The test specimen exterior surface extends around the test specimen between the first end surface and the second end surface. The configuration of the test specimen can be the conventional “dumbbell” configuration. The configuration can be cylindrical, for example a general cylindrical rod configuration that extends between a first circular end surface and a second circular end surface. The configuration of the test specimen could also be rectangular, for example a general rectangular strip configuration that extends between a first rectangular end surface and a second rectangular end surface. The test specimen may have a rectangular configuration, but the concepts of this disclosure can also apply to a test specimen having a cylindrical configuration.

A marking is provided on the exterior surface of the test specimen. The marking is integral with the test specimen and is integral with the exterior surface of the test specimen. The marking identifies a property or properties of the material of the test specimen and provides the test specimen with properties identification. For example, the marking can identify a material of the test specimen. The marking can identify a density of the material of the test specimen and/or a grain structure of the material of the test specimen. Where the material of a test specimen is an alloy, the marking can identify the alloy composition of the material of the test specimen. The marking can also identify the geometric location of the material of the test specimen in the material of the product from which the test specimen was taken. For example, the marking can identify where the material of the test specimen was spatially located in the material of the product from which the test specimen was removed or cut. The marking could also indicate the orientation of the material of the test specimen relative to the three dimensional configuration of the material of the product from which it was cut, or the sample of material from which it was cut. For example, the marking could identify the length dimension of the specimen being positioned in or along the X, Y or Z axis of the material of the product from which it was cut, or the sample of material from which it was cut. This would enable the identification of the location and orientation of the material of the test specimen relative to the material of the product or sample, which are critical to relating properties of the material of the specimen to specific locations and orientations in the material of the product or sample being tested.

As stated earlier, the test specimen of material may have the conventional “dumbbell” configuration with a middle or center portion of the test specimen having a cross section area that is smaller than cross section areas of the opposite end portions of the test specimen. The rectangular configuration of the test specimen has a length dimension, a width dimension, and a thickness dimension of the test specimen. The length dimension, the width dimension, and the thickness dimension are mutually perpendicular.

The test specimen has first and second length surfaces that extend along the length dimension of the test specimen on opposite sides of the test specimen, for example front and rear surfaces of the test specimen. The first and second length surfaces have been produced by electric discharge machining, micro-machining, and/or laser machining.

The test specimen has first and second width surfaces that extend along the width dimension of the test specimen on opposite sides of the test specimen, for example the top and bottom surfaces of the test specimen. The first and second width surfaces have been produced by electric discharge machining, micro-machining, and/or laser machining.

The test specimen also has first and second thickness surfaces or first and second end surfaces that extend along the thickness dimension of the test specimen at opposite ends of the test specimen, for example the left and right end surfaces of the test specimen. The first and second thickness surfaces have been produced by electric discharge machining, micro-machining, and/or laser machining.

The marking is on at least one of the surfaces of the test specimen. The marking identifies a physical property(ies) of the material of the test specimen, and preferably identifies several physical properties of the material of the test specimen. The marking is produced on the surface of the test specimen by electric discharge machining, micro-machining, and/or laser machining as the test specimen is produced. This avoids any mistakes in the test specimen marking and prevents the marking from being easily removed from the test specimen.

The first and second thickness surfaces are the respective first and second end surfaces at opposite ends of the length dimension of the test specimen and at opposite ends of the first and second length surfaces of the test specimen. In exemplary embodiments, the first and second end surfaces of the test specimen are accessible by a wire of an electric discharge machine as the test specimen is produced by electric discharge machining. The end surfaces being accessible by the electric discharge machining wire enables producing a marking on the first and second end surfaces as the test specimen is produced by the wire of the electric discharge machine. The marking being produced on the end surfaces, and the marking being produced on only the first end surface facilitates or simplifies the production of the marking on the test specimen as the test specimen is produced.

In one example, the test specimen is cut or produced by electric discharge machining from a sample block of material the test specimen is to test. In this example, the test specimen is a first test specimen that has been produced by being cut by electric discharge machining from the sample block of material. Additional test specimens can also be cut from the sample block of material. In this example, a second test specimen is also cut or produced by electric discharge machining from the same block of material to be tested by the first specimen. In other examples, three or more additional test specimens are cut by electric discharge machining from the block of material.

As with the first test specimen, the second test specimen has first and second length surfaces on opposite sides of the second test specimen. The first and second length surfaces on the second test specimen extend along a length dimension of the second test specimen and have been produced by electric discharge machining, micro-machining, and/or laser machining.

The second test specimen has first and second width surfaces on opposite sides of the second test specimen. The first and second width surfaces extend along a width dimension of the second test specimen and have been produced by electric discharge machining, micro-machining, and/or laser machining.

The second test specimen also has first and second thickness surfaces or first and second end surfaces on opposite ends of the second test specimen. The first and second end surfaces on the second test specimen extend along the thickness dimension of the second test specimen and have been produced by electric discharge machining, micro-machining, and/or laser machining.

There is also a marking on at least one of the surfaces of the second test specimen. The marking on the second test specimen has been produced by electric discharge machining, micro-machining, and/or laser machining as the surfaces of the second test specimen have been produced by electric discharge machining, micro-machining, and/or laser machining. The marking identifies a property of the material of the second test specimen, and preferably identifies several physical properties of the material of the second test specimen. As with the first test specimen, the marking has been produced by electric discharge machining, micro-machining, and/or laser machining on one of the first and second end surfaces of the second specimen.

In the sample block of material, the first and second end surfaces of the first test specimen are coplanar with the respective first and second end surfaces of the second test specimen as the first test specimen and the second test specimen are produced by electric discharge machining, micro-machining, and/or laser machining. The marking on the surface of the first test specimen was produced by electric discharge machining, micro-machining, and/or laser machining on the first end surface of the first test specimen and the marking on the surface of the second test specimen was produced by electric discharge machining, micro-machining, and/or laser machining on the first end surface of the second test specimen.

The marking is a linear marking on the first end surface of the first test specimen and on the first end surface of a second test specimen. The first end surface of the first test specimen and the first end surface of the second test specimen have a same shape or a same area configuration. In exemplary embodiments, the marking on the first end surface of the first test specimen and the marking on the first end surface of the second test specimen are produced simultaneously by the electric discharge machining wire contacting linearly across different locations on the area configuration of each surface. The marking on the area configuration of the first end surface of first test specimen and the marking on the area configuration of the first end surface of the second test specimen being at different locations on the area of configuration identifies the relative positions of the first test specimen and the second test specimen in the sample block of material from which the specimens were cut by electric discharge machining.

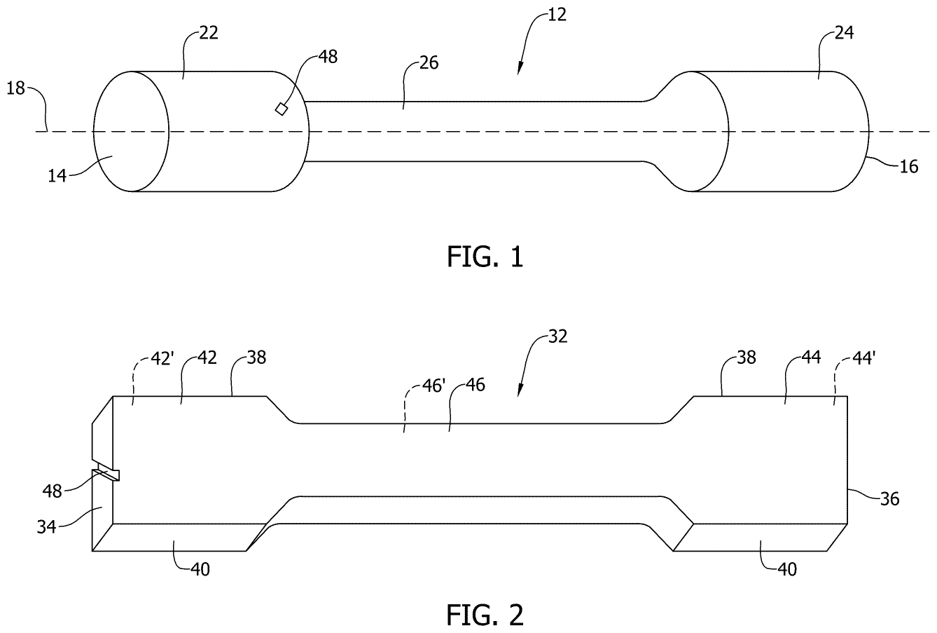

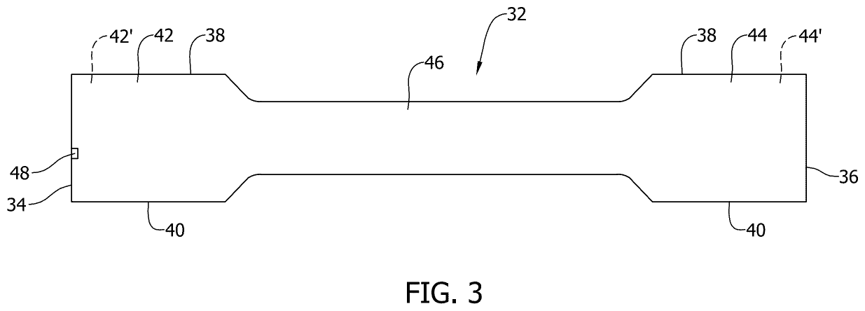

With reference now to the figures, FIG. 1 is a representation of an exemplary embodiment of a miniature test specimen 12. As an example, a typical miniature or subsize test specimen has a length of 100 mm (but could also be significantly lower), a gauge length of 25 mm and a gauge section width of 6 mm. Although the test specimen 12 of FIG. 1. is described as a miniature test specimen, the features of the test specimen 12 and the manner in which the specimen 12 is produced can be applied to test specimens of various sizes.

As represented in FIG. 1, the test specimen 12 has an exterior surface with an elongate length that extends between a first end surface 14 and a second end surface 16 at opposite ends of the specimen 12. The test specimen 12 represented in FIG. 1 has the conventional “dumbbell” configuration. The first end surface 14 and the second end surface 16 are circular and are parallel surfaces. The first end surface 14 and second end surface 16 are coaxial and have a center axis 18 that extends through the centers of the end surfaces 14, 16 and through the center of the length of the specimen 12. The exterior surface of the specimen 12 extends around the center axis 18 and extends along the length of the specimen 12 between the first end surface 14 and the second end surface 16.

With the example of the specimen 12 represented in FIG. 1 having the conventional dumbbell configuration, the exterior surface has a first end area 22 of the exterior surface adjacent the first end surface 14 and a second end area 24 of the exterior surface adjacent the second end surface 16. The first end area 22 and the second end area 24 are cylindrical and are configured for engagement with a specimen holding device, for example a clamping device of a conventional testing apparatus. The first end area 22 of the exterior surface and the second end area 24 of the exterior surface have same cross section dimensions or same diameter dimensions. The first end area 22 is a first shoulder potion of the dumbbell configuration and the second end area 24 is a second shoulder portion of the dumbbell configuration.

The specimen 12 also has a middle area 26 or center area of the exterior surface between the first end area 22 and the second end area 24 of the exterior surface. The middle or center area 26 of the exterior surface has a cross section dimension or a cross section diameter that is less than or smaller than the cross section dimension or diameter of the first end area 22 and the second end area 24 of the exterior surface. The middle or center area 26 of the exterior surface is the conventional testing area of the specimen 12. The middle or center area 26 is the gauge portion of the dumbbell configuration. The gauge portion is at an intermediate location of the exterior surface of the test specimen 12 and the first shoulder portion and second shoulder portion are at opposite ends of the gauge portion.

FIG. 2 is a representation of the miniature test specimen 32 of this disclosure. Although the test specimen 32 of FIG. 2 is described as a miniature test specimen, the features of the test specimen 32 and the manner in which the test specimen is produced can be applied to test specimens of various sizes. Thus, the features of the test specimen 32 and the manner in which it is produced should not be interpreted as being limited to miniature test specimens. The test specimen 32 can be constructed of various different types of materials desired to be tested. For example, the test specimen can be constructed of a metal, a metal alloy, metal matrix composites, or any other equivalent type of material that is desired to be tested.

The test specimen 32 has a “dumbbell” configuration similar to that of the first described specimen 12, except that the configuration is generally rectangular instead of cylindrical. Although the test specimen 32 of this disclosure has a rectangular configuration, the concepts of this disclosure also apply to a test specimen having a cylindrical configuration such as the first described test specimen 12 of FIG. 1. The rectangular configuration of the test specimen 32 has a length dimension, a width dimension and a thickness dimension. The length dimension, the width dimension and the thickness dimension are mutually perpendicular.

As represented in FIG. 2, the test specimen 32 has a first end surface 34 and an opposite second end surface 36 that are rectangular and are parallel. The specimen 32 also has a first width surface 38 and a second width surface 40 that are parallel surfaces on opposite sides of the test specimen, for example the top and bottom of the specimen 32. The specimen 32 further has a first length surface and a second length surface that are parallel surfaces on opposite sides of the specimen, for example the front and rear of the specimen. As represented in FIG. 2, the first length surface and the second length surface are comprised of first end areas 42, 42′ on the opposite sides of the specimen 32 and second end areas 44, 44′ on the opposite sides of the specimen 32. The first end areas 42, 42′ and second end areas 44, 44′ are at opposite ends of the first and second length surfaces of the specimen 32 and are flat, parallel surfaces. The surfaces of the first end areas 42, 42′ and the second end areas 44, 44′ are configured for engagement with specimen holding devices, for example clamping devices of a conventional testing apparatus.

With the test specimen 32 represented in FIG. 2 having the conventional “dumbbell” configuration, the first and second length surfaces of the specimen have middle areas or center areas 46, 46′ on opposite sides of the specimen. The middle or center areas 46, 46′ of the length surfaces have a cross section dimension that is less than or smaller than the cross section dimension the first end areas 42, 42′ and second end areas 44, 44′ of the length surfaces. The middle or center areas 46, 46′ of the length surfaces are the conventional testing areas of the specimen 32.

Thus, as represented in FIG. 2, the test specimen 32 has a first length surface, or a front surface that is comprised of the first end area 42, the second end area 44 and the center area 46 of the first length surface. The test specimen 32 also has a second length surface, or a rear surface that is comprised of the first end area 42′, the second end area 44′ and the center area 46′ of the second length surface. The first and second length surfaces extend along the length dimension of the test specimen 32 on opposite sides of the test specimen or the opposite front and rear surfaces of the test specimen. As will be explained, the first and second length surfaces are produced by electric discharge machining.

As represented in FIG. 2, the test specimen 32 also has first 38 and second 40 width surfaces that extend along the length dimension of the test specimen. The first 38 and second 40 width surfaces extend across the width dimension of the test specimen on opposite sides of the specimen, for example the opposite top and bottom surfaces of the test specimen. The first 38 and second 40 width surfaces are produced by electric discharge machining as will be explained.

Also as represented in FIG. 2, the test specimen 32 has a first end surface 34 or first thickness surface and a second end surface 36 or second thickness surface that extend across the thickness dimension of the test specimen on opposite ends of the test specimen, for example the opposite left end surface 34 and right end surfaces 36 of the test specimen. The first end surface 34 or first thickness surface and the second end surface 36 or second thickness surface are produced by electric discharge machining as will be explained.

A marking 48 is provided on the exterior surface of the test specimen 12 represented in FIG. 1 and on the exterior surface of the test specimen 32 represented in FIG. 2. The marking 48 is shown as being positioned on the first end area 22 of the specimen 12 of FIG. 1, and on the first end surface 34 or first thickness surface 34 of the specimen 32 of FIG. 2. The marking 48 is integral with the test specimen 32 and more specifically is integral with the exterior surface of the test specimen 32. With the marking 48 being integral with the test specimen 32, the marking cannot easily be removed from the test specimen or obscured on the test specimen.

With regard to the specimen of this disclosure represented in FIG. 2, the marking 48 can also be located on other surfaces of the specimen 32. For example, the marking 48 can be positioned on the width surfaces 38, 40. But the marking 48 is not positioned on the middle or center area 46 of the specimen 32 to prevent the presence of the marking from interfering with the testing of the specimen.

The marking 48 is represented in FIG. 2 as having the configuration of a single line or strip. This is due to the marking having been produced by a linear electric discharge machining wire as will be explained. However, this is only one example of a possible configuration of the marking 48. The marking 48 can be a single marking as represented in FIG. 2 or could be comprised of multiple markings. The marking 48 could be any other representation that is visually discernible on the test specimens 32. The marking 48 only needs to be discernible and recognizable as representing or identifying a property or properties of the test specimen 32 and thereby provides the test specimen with properties identification.

The marking 48 can immediately identify a property of the test specimen 32 or can be used to identify a property or properties of the test specimen 32 by first visually observing the marking 48, and then referring to a reference such as a manual, catalog, a data base, or other equivalent type of information record that is separate from the test specimen 32 and associates the marking 48 with properties of the test specimen set forth in the reference.

The marking 48 can identify a material of a test specimen 32, a density of the test specimen, a grain structure of the test specimen, and/or a composition of the test specimen. The marking 48 can also identify the geometric location of the test specimen in the material of the product. For example, the marking 48 can identify where the test specimen was spatially located in the material of the product or in a sample block of material from which the test specimen was cut. The marking 48 can also indicate the orientation of the test specimen relative to the product or sample block of material. For example, the marking 48 can identify the major length dimension of the specimen being positioned in or along the X, Y or Z axis of the product or sample block of material. This would enable the identification of the location and orientation of the test specimen relative to the product or sample block of material, which are critical to relating properties of the material of the product or sample block to specific locations and orientations in the product or sample block that is being tested. Furthermore, the marking 48 can identify the manner in which the object or product of the test specimen was produced.

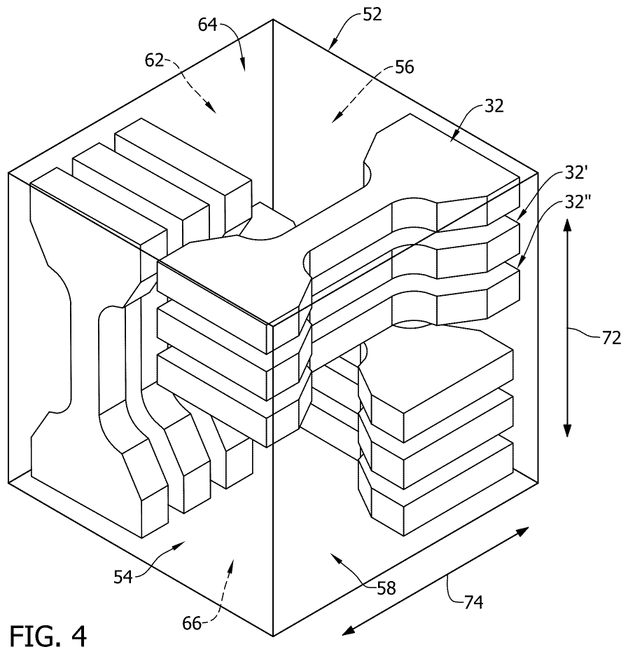

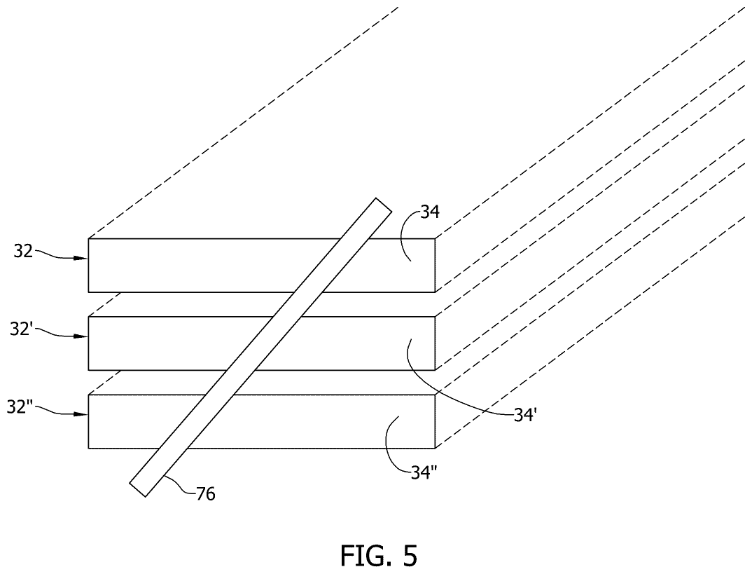

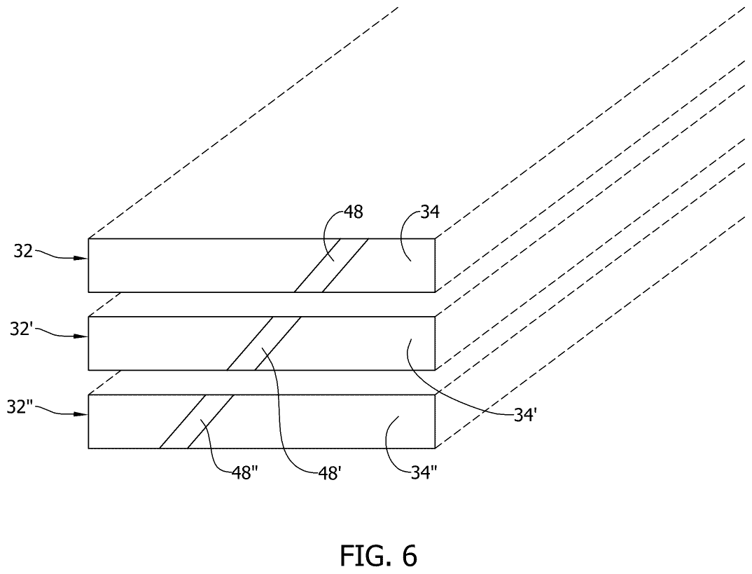

FIG. 4 is a representation of a perspective view of a sample block of material 52 from which test specimens 32, 32′, 32″ of this disclosure are produced with the test specimens 32, 32′, 32″ in their relative positions in the sample block of material 52. FIGS. 5 and 6 are representations of perspective views of the test specimens 32, 32′, 32″ in their relative positions removed from the sample block of material 52. The material can be a metal, a metal alloy, a metal matrix composite, or any other equivalent type of material that is desired to be tested. The block 52 is represented as having a front surface 54 and a parallel, opposite rear 56 surface, a right surface 58 and a parallel, opposite left surface 62, and a top surface 64 and a parallel, opposite bottom surface 66.

The specimens 32, 32′, 32″ are represented in FIG. 4 as being three in number and arranged in three stacks at positions in the sample block of material 52 from where they will be produced. It should be understood that there can be more than the three specimens arranged in three stacks produced from the block 52. Additionally, the specimens 32, 32′, 32″ are represented as being positioned in three stacks of three specimens each in the three dimensional volume of the block 52. Each of the three stacks is oriented at a different orientation in the block 52. The three stacks of specimens 32, 32′, 32″ at three different orientations in the sample block of material 52 is only one example as to how specimens can be oriented and positioned in the sample block of material 52.

As represented in FIGS. 4, 5, and 6, the three specimens 32, 32′, 32″ are oriented in the sample block of material 52 with their first end surfaces 34, 34′, 34″ or thickness surfaces being coplanar and being positioned in a vertical plane within the three dimensional volume of the block 52. The width surfaces 38, 38′, 38″, 40, 40′, 40″ of the specimens 32, 32′, 32″ have portions that are coplanar and are positioned in vertically oriented planes. The length surfaces of the specimens 32, 32′, 32″ are positioned parallel to each other and in horizontal planes that are spaced vertically from each other.

The relative positions of the specimens 32, 32′, 32″ in the sample block of material 52 facilitates their being produced or cut from the sample block 52 by electric discharge machining. A wire 72 of an electric discharge machine that is oriented vertically as schematically represented in FIG. 4 can be controlled, for example computer numerical controlled (CNC) to move through and cut through the sample block of material 52. The wire 72 can be controlled to cut the first end surfaces or thickness surfaces 34, 34′, 34″ of the specimens 32, 32′, 32″ simultaneously from the sample block of material 52, and cut the width surfaces of the test specimens 32, 32′, 32″ simultaneously from the block of material 52. The wire of the electric discharge machine can then be controlled to move to a horizontal orientation of the wire 74 represented in FIG. 4. The wire 74 can then be controlled to move through and cut through the sample block of material 52 and cut the opposite length surfaces of the test specimens 32, 32′, 32″ from the block of sample material 52.

In the above manner, the test specimens 32, 32′, 32″ are produced from the block of sample material 52 by electric discharge machining.

Furthermore, with the first end surfaces 34, 34′, 34″ or the first thickness surfaces of the test specimens 32, 32′, 32″ being coplanar, as the surfaces are cut from the sample block of material 52, the wire 76 of the electric discharge machine can be moved to a further orientation other than the vertical or horizontal orientation described. For example, the electric discharge machine wire 76 can be computer numerical controlled (CNC) by the electric discharge machine to be moved to the angled orientation of the wire relative to the first end surfaces 34, 34′, 34″ or first thickness surfaces of the test specimens 32, 32′, 32″ represented in FIG. 5. In the orientation of the electric discharge machining wire 76 represented in FIG. 5, the wire 76 can be moved into simultaneous engagement with the first end surfaces 34, 34′, 34″ of the three test specimens 32, 32′, 32″ and simultaneously produce markings 48, 48′, 48″ that are integral with the first end surfaces 34, 34′, 34″. The angled electric discharge machine wire 76 can be controlled to be moved into contact with the first end surfaces 34, 34′, 34″ at several locations on the first end surfaces 34 to produce a distinct marking 48, 48′, 48″ on the first end surfaces. For example, a barcode type marking, or other equivalent type of unique marking can be simultaneously produced by the wire 76 on the first end surfaces 34, 34′, 34″. The markings 48, 48′, 48″ produced on the first end surfaces 34, 34′, 34″ of the test specimens 32, 32′, 32″ can be controlled to produce patterns or markings that identify physical properties of the material of the test specimens 32, 32′, 32″ such as those properties discussed earlier.

Furthermore, as represented in FIG. 6, the first end surfaces 34, 34′, 34″ cut by the vertically oriented wire 72 and then by the horizontally oriented wire 74 are coplanar and have same area configurations. With the electric discharge machining wire 76 then being oriented at an angle as the wire contacts the previously cut first end surfaces 34, 34′, 34″ of the test specimens 32, 32′, 32″, the wire 76 simultaneously produces the markings 48, 48′,48″ in the area configurations of the first end surfaces 34, 34′, 34″ at different locations of the markings 48, 48′, 48″ in the area configurations. This positioning of the markings 48, 48′, 48″ at different locations in the area configurations of the first end surfaces 34, 34′, 34″ is used to identify the relative positions and orientations of the test specimens 32, 32′, 32″ in the three-dimensional volume of the sample block of material 52.

For example, as represented in FIG. 6, in the vertical stack orientation of the test specimens 32, 32′, 32″ cut from the sample block of material 52, the marking 48″ produced by the angled wire 76 of the electric discharge machine on the area configuration of the first end surface 34″ of the lower specimen 32″ is positioned to the left of the markings 48′ on the area configuration of the first end surface 34′ of the middle specimen 32′ which is positioned to the left of the marking 48 on the area configuration of the first end surface 34 of the upper specimen 32. This identifies the marking 34″ as being on the test specimen 32″ positioned at the bottom of the vertical stack of test specimens. This also identifies the test specimen 32″ as being the bottom test specimen in the vertical stack of test specimens cut from the sample block of material 52. In a like manner, the position of the marking 48 on the area configuration of the first end surface 34 of the test specimen 32 represented in FIG. 6 being positioned to the right of the markings 48′, 48″ on the area configurations of the first end surfaces 34′, 34″ of the other test specimens 32′, 32″ identifies the test specimen 32 as being at the top of the stack of vertically oriented test specimens cut from the sample block of material 52 and being cut from the material at the top of the sample block of material 52.

Still further, the positioning of the marking 48′ in the first end surface 34′ of the test specimen 32′ in the middle of the area configuration of the first end surface 34′ identifies the test specimen 32′ as being positioned or oriented in the middle of the stack of test specimens 32, 32′, 32″ cut from the block of sample material 52 and being cut from the material at the middle of the sample block of material 52.

Thus, the markings 48, 48′, 48″ produced by electric discharge machining as the test specimens 32, 32′, 32″ are produced by electric discharge machining identify physical properties of the test specimens and the positions and orientations of the test specimens in the block of sample material 52 as the test specimens are produced.

In view of the above, it will be seen that the several objects and advantages of the present invention have been achieved and other advantageous results have been obtained.

Example embodiments are provided so that this disclosure will be thorough, and will fully convey the scope to those who are skilled in the art. Numerous specific details are set forth such as examples of specific components, electronic devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known electronic device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally,” “about,” and “substantially,” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper” and the like, may be used herein for ease of description to describe one element or feature's relationship to another element(s) or feature(s) as illustrated in the figures. Spatially relative terms may be intended to encompass different orientations of the electronic device in use or operation in addition to the orientation depicted in the figures. For example, if the electronic device in the figures is turned over, elements described as “below” or “beneath” other elements or features would then be oriented “above” the other elements or features. Thus, the example term “below” can encompass both an orientation of above and below. The electronic device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A test specimen comprising:
an exterior surface on the test specimen;
a marking on the exterior surface of the test specimen, the marking produced integrally with the exterior surface of the test specimen when the exterior surface of the test specimen was produced by electric discharge machining, micro-machining, and/or laser machining; and
the marking identifying at least one property of the test specimen.

2. The test specimen of claim 1, wherein:
the exterior surface of the test specimen has a length defined between first and second end surfaces of the exterior surface;
the first end surface and the second end surface are at opposite ends of the test specimen; and
the marking is on the first end surface of the exterior surface.

3. The test specimen of claim 1, wherein:
the exterior surface of the test specimen has a length and first and second end areas at opposite ends of the length of the exterior surface;
the exterior surface has a middle area between the first end area and the second end area;
the test specimen has a middle area cross section dimension at the middle area of the exterior surface;
the test specimen has a first end area cross section dimension at the first end area and a second end area cross section dimension at the second end area;
the first end area cross section dimension of the first end area is larger than the middle area cross section dimension of the middle area of the exterior surface; and
the second end area cross section dimension of the second end area is larger than the middle area cross section dimension of the middle area of the exterior surface.

4. The test specimen of claim 2, wherein the first end area of the exterior surface and the second end area of the exterior surface are configured for engagement with a holding device of a testing apparatus.

5. The test specimen of claim 1, wherein:
the test specimen is an electric discharge machined test specimen; and
the marking on the exterior surface of the test specimen is an electric discharge machined marking produced by electric discharge machining on the exterior surface of the test specimen as the test specimen was produced by electric discharge machining.

6. The test specimen of claim 1, wherein:
the test specimen comprises a test specimen cut from a block of material by electric discharge machining; and
the marking on the exterior surface of the test specimen comprises a marking cut by electric discharge machining on the exterior surface of the test specimen as the test specimen was cut from the block of material by electric discharge machining.

7. The test specimen of claim 1, wherein:
the test specimen is one test specimen of a plurality of test specimens cut from a block of material by electric discharge machining; and
the marking on the exterior surface of the test specimen comprises a marking cut by electric discharge machining on the exterior surface of the test specimen as the plurality of test specimens were cut from the block of material by electric discharge machining.

8. A test specimen of a material, the test specimen comprising:
a length dimension, a width dimension, and a thickness dimension that are mutually perpendicular;
first and second length surfaces on the test specimen that extend across the length dimension on opposite sides of the test specimen, the first and second length surfaces produced by electric discharge machining, micro-machining, and/or laser machining;
first and second width surfaces on the test specimen that extend across the width dimension on opposite sides of the test specimen, the first and second width surfaces produced by electric discharge machining, micro-machining, and/or laser machining;
first and second end surfaces on the test specimen that extend across the thickness dimension at opposite ends of the test specimen, the first and second end surfaces produced by electric discharge machining, micro-machining, and/or laser machining; and
a marking on one of the surfaces, the marking produced by electric discharge machining, micro-machining, and/or laser machining as the one of the surfaces was produced by electric discharge machining, micro-machining, and/or laser machining.

9. The test specimen of claim 8, wherein the marking identifies at least one physical property of the material of the test specimen.

10. The test specimen of claim 8, wherein the marking identifies several physical properties of the material of the test specimen.

11. The test specimen of claim 8, wherein the marking is on one of the first and second end surfaces of the test specimen.

12. The test specimen of claim 8, wherein the test specimen is a first test specimen produced by electric discharge machining from a block of the material, and wherein:
a second test specimen produced by electric discharge machining from the block of the material has:
first and second length surfaces on opposite sides of the second test specimen, the first and second length surfaces on the second test specimen produced by electric discharge machining;
first and second width surfaces on opposite sides of the second test specimen, the first and second width surfaces on the second test specimen produced by electric discharge machining;
first and second end surfaces on opposite ends of the second test specimen, the first and second end surfaces on the second test specimen produced by electric discharge machining; and
a marking on one of the surfaces of the second test specimen produced by electric discharge machining as the one of the surfaces was produced by electric discharge machining.

13. The test specimen of claim 12, wherein:
the first and second end surfaces of the first test specimen and the respective first and second end surfaces of the second test specimen are coplanar;
the marking on the one surface of the first test specimen is produced by electric discharge machining on the first end surface of the first test specimen; and
the marking on the one surface of the second test specimen is produced by electric discharge machining on the first end surface of the second test specimen simultaneously with the marking being produced by electric discharge machining on the first end surface of the first test specimen.

14. The test specimen of claim 8, wherein the test specimen is a first test specimen that was produced by electric discharge machining from a block of material, the marking on the first test specimen was produced by electric discharge machining on the first end surface of the first test specimen, and wherein:
a second test specimen produced by electric discharge machining from the block of material has:
first and second end surfaces on opposite ends of the second test specimen, the first and second end surfaces of the second test specimen coplanar with the respective first and second end surfaces of the first test specimen as the first test specimen and the second test specimen were produced by electric discharge machining from the block of material; and
a marking on the second test specimen produced by electric discharge machining on the first end surface of the second test specimen.

15. The test specimen of claim 14, wherein the marking is a linear marking on the first end surface of the first test specimen and on the first end surface of the second test specimen.

16. The test specimen of claim 14, wherein:
the first end surface of the first test specimen and the first end surface of the second test specimen have a same area configuration; and
the marking on the first end surface of the first test specimen and the marking on the first end surface of the second test specimen are at different locations on the area configuration.

17. A method of producing a test specimen of a material, the method comprising:
producing first and second length surfaces on opposite sides of the test specimen by electric discharge machining, micro-machining, and/or laser machining; and
producing first and second width surfaces on opposite sides of the test specimen by electric discharge machining, micro-machining, and/or laser machining;
producing first and second end surfaces on opposite ends of the test specimen by electric discharge machining, micro-machining, and/or laser machining; and
producing a marking on one of the surfaces of the test specimen by electric discharge machining, micro-machining, and/or laser machining as the test specimen is produced by electric discharge machining, micro-machining, and/or laser machining, the marking identifying at least one property of the material of the test specimen.

18. The method of claim 17, wherein the method includes producing the marking on only the first end surface of the test specimen by electric discharge machining.

19. The method of claim 18, wherein the method includes:
producing a second test specimen having first and second end surfaces on opposite ends of the second test specimen; and
producing a marking on the first end surface of the second test specimen by electric discharge machining as the second test specimen is produced by electric discharge machining.

20. The method of claim 19, wherein the method includes producing the marking on the first end surface of the test specimen and producing the marking on the first end surface of the second test specimen with a linear marking on the first end surface of the test specimen and on the first end surface of the second test specimen.
